(19) United States
(12) Patent Application Publication
(10) Pub. No.: US 2012/0107217 A1
(43) Pub. Date: May 3, 2012

(54) METHOD FOR PRODUCING OLIGOHALOGEN SILANES

(75) Inventors: Jan Kunert, Muenchen (DE); Christian Hofhansl, Muenchen (DE)

(73) Assignee: WACKER CHEMIE AG, Muenchen (DE)

(21) Appl. No.: 13/379,466

(22) PCT Filed: Jun. 16, 2010
(86) PCT No.: PCT/EP2010/058426

§ 371 Date: Dec. 20, 2011

(30) Foreign Application Priority Data
Jun. 26, 2009 (DE) 102009027241.0

(51) Int. Cl. C01B 33/107

(52) U.S. Cl. 423/342

(57) ABSTRACT

The invention relates to a method for producing oligohalogen silanes, selected from oligohalogen silanes of the general formulas (1) and (2): SiₓX₂ₙ₊₂ (1), SiₘX₂ₘ (2), wherein a mixture comprising silicon and metal halogenide selected from Ti, Zr, Hf, V, Nb, Mo, W, Fe, Co, Ni, Gu, Cd, In, Sn, P, Sb, Bi, S, Se, Te and Pb and mixtures thereof is converted at a temperature of −125° C. to 1100° C. and the oligohalogen silanes formed are removed by means of a carrier gas selected from N₂, noble gases, CH₃Cl, HCl, CO₂, CO, H₂, and SiCl₄, where X is selected from Cl, Br and J, n is a whole number from 2 to 10, and m is a whole number from 3 to 10.

The invention relates to the preparation of oligohalosilanes from a mixture of silicon and halide of metal.

Oligohalosilanes, especially Si₂Cl₆ and Si₃Cl₈, constitute valuable precursors for the electronics/photovoltaics sector.

Hexachlorodisilane is prepared in significant amounts typically from silicides. A disadvantage of most of the processes specified, as described in JP 2006169012 A2, is that they lead to highly contaminated crude products with a multitude of by-products, the necessary removal/workup of which is usually found to be inconvenient and difficult, and can be accomplished by methods including extraction and/or distillation only with considerable energy expenditure. One process for distillative purification of hexachlorodisilane is described in DE 102007000841A1.

I) One possible starting source/raw material for higher chlorosilanes is, for example, the process gas stream which is obtained in the Siemens process for the production of polycrystalline Si. This is described, for example, in JP 2007284280 A2. The Siemens process uses thin silicon rods which are heated in a gas atmosphere of trichlorosilane and hydrogen. From the trichlorosilane, silicon is deposited gradually on the rods, which in this way grow to form thicker columns of polysilicon.

II) The product stream which arises in the chlorination of Si or Si alloy can also be taken as a source for higher chlorosilanes by workup: this is described, for example, in JP 59232910 A JP.

The preparation of oligochlorosilanes from mercury silyl compounds and chlorosilanes is described in the thesis by J. R. Joiner, “Systematic Preparation of Chloropolysilanes and Chlorosilylgermanes”, Tufts University, 1972.

The invention provides a process for preparing oligohalosilanes which are selected from oligohalosilanes of the general formulae (1) and (2)

SiₙX₂ₙ₊₂ (1)

SiₘX₂ₘ (2)

in which a mixture comprising silicon and halide of metal which is selected from Ti, Zr, Hf, V, Nb, Mo, W, Fe, Co, Ni, Cu, Cd, In, Sn, P, Sb, Bi, S, Se, Te and Pb and mixtures thereof,
is converted at a temperature of −125° C. to 1100° C. and the oligohalosilanes formed are removed with a carrier gas which is selected from N₂, noble gases, CH₃Cl, HCl, CO₂, CO, H₂ and SiCl₄,
where
X is selected from Cl, Br and I,
n is an integer from 2 to 10 and
m is an integer from 3 to 10.

The process constitutes a simple route to the oligo-chlorosilanes. It is possible to use inexpensive starting materials. The by-products obtained are predominantly high-purity halosilanes which, due to the high boiling point differences, can be worked up by distillation in a simple manner, and which can be used in many chemical processes.

The silicon used in the process contains preferably not more than 5% by weight, more preferably not more than 2% by weight and especially not more than 1% by weight of other elements as impurities. The impurities, which make up at least 0.01% by weight, are preferably elements selected from Fe, Ni, Al, Ca, Cu, Zn, Sn, C, V, Mn, Ti, Cr, B, P, O. Preference is given to using silicon as it is suitable for use in Rochow processes, for example described in DE 4303766 A1, to which reference is made explicitly.

The metal halide melts preferably at not less than −125° C., especially not less than 50° C., and preferably at not more than 1050° C., more preferably not more than 800° C., especially not more than 600° C., especially preferably not more than 400° C.

A preferred halogen X is chlorine.

Preference is given to the use of halogen compounds of the metals Fe, V, Mo, Ni, Cu, Cd, Sn, P, Sb, Bi, Pb, especially of Cu, Sn, P, Fe, V, Mo, Cd.

In the case of use of metal halides which do not melt at the process temperature, the additional presence of other metal halides is advantageous, especially of other metal halides which promote the formation of eutectic melts with the metal halides of Ti, Zr, Hf, V, Nb, Mo, W, Fe, Co, Ni, Cu, Cd, In, Sn, P, Sb, Bi, S, Se, Te and Pb.

Preferred other metal halides are the halides Li, Na, K, Rb, Cs, Be, Mg, Ca, Sr, Ba, La, Ce, Pr, Nd, Sm, Eu, Gd, Tb, Dy, Ho, Er, Tm, Yb, Lu, Zn, Al, Ga, especially the chlorides. Particularly preferred other metal halides are the chlorides of main groups 1 and 2, and also Zn, Al, Ga, especially of Zn, Al, Ga, Mg, Ca, Sr, Cs.

The process temperature is preferably not less than 150° C., especially not less than 250° C., and preferably not more than 800° C., more preferably not more than 600° C., especially not more than 450° C.

It is possible to use pure carrier gases; it is also possible to use mixtures of carrier gases. If the carrier gases used are noble gases, preference is given to helium and argon. The carrier gas is preferably passed over the mixture comprising silicon and halide of metal, or carrier gas flows through the mixture. The carrier gas is preferably heated to process temperature before it removes the oligohalosilanes from the mixture comprising silicon and halide of metal.

If the carrier gas is selected from N₂, noble gases, CO₂, CO and SiCl₄, silicon halides are formed as a by-product, especially SiX₄ and HSiX₃. If the carrier gas is selected from HCl and H₂, the by-products formed are silicon halides, some of which contain hydrogen. If the carrier gas is CH₃Cl, the by-products formed are methylchlorosilanes.

Typically, not less than 1% by weight, preferably not less than 2% by weight, especially not less than 5% by weight, and preferably not more than 50% by weight, more preferably not more than 30% by weight, especially not more than 15% by weight, of the products removed with the carrier gas are oligohalosilanes of the general formulae (1) and (2); the remainder are by-products.

The oligohalosilanes of the general formulae (1) and (2) may be linear or branched. The oligohalosilanes of the general formula (2) contain a cycle.

Preferably, oligohalosilanes are formed in which n has the values of 2 to 6, especially 2, 3 and 4, and m has the values of 4, 5 or 6, especially 2, 3 and 4.

For 100 parts by weight of silicon, preferably not less than 0.1 part by weight, more preferably not less than 0.5 part by weight, especially not less than 1 part by weight, and preferably not more than 50 parts by weight, more preferably not more than 15 parts by weight, especially not more than 6 parts by weight, of metal halide are used.

The process can be performed in all heatable apparatuses which have mixing characteristics, through which a carrier gas can flow or which can be charged with a carrier gas, and reach the necessary temperature level. The apparatuses are preferably charged and emptied under the carrier gas.

The carrier gas stream laden with oligohalosilanes and by-products is preferably cooled by means of a condensation stage, and the oligohalosilanes are obtained in this way. The mixture of oligohalosilanes and by-products is preferably separated by distillation into its different fractions.

Suitable apparatuses are, for example, rotary tube furnaces, screw heat exchangers, cone mixers, vertical and horizontal mixers, and fluidized bed driers. The process execution can be performed either continuously or batchwise.

All above symbols in the above formulae are each defined independently of one another. In all formulae, the silicon atom is tetravalent.

In the examples which follow, unless stated otherwise in each case, all amounts and percentages are based on weight, all pressures are 0.10 MPa (abs.) and all temperatures are 20° C.

### EXAMPLE 1

In an N₂-inertized rotary tube furnace (5 revolutions per min), 500 g of a mechanical blend consisting of 99.45% by weight of crude silicon (quality for the methylchlorosilane preparation according to Rochow) and 0.55% by weight of metal halide mixture of CuCl, ZnCl₂ and tin chloride were brought to a temperature range of 280-320° C. under a gentle N₂ stream (150 ml/min) and treated thermally for a period of 20-60 min. The weight ratio of Cu metal to Zn is 10 to 1, and the Sn content based on the total metal content is 100 ppm. Under these conditions, the metal chlorides react with the Si to form gaseous chlorosilane products, which are removed continuously from the rotary tube furnace by means of the N₂ carrier gas and are condensed out by a downstream cooling unit (cooling temperature −70° C.) After the reaction has ended (no condensation in the cooler), the reaction is stopped and the composition of the condensate formed (reaction mixture) is determined with the aid of GC, MS and NMR analysis. The yield of oligochlorosilanes (based on the total metal chloride content) is reproduced in table 1. The main components of the condensate (SiCl₄, SiHCl₃ and Si₂Cl₆) are listed in table 2. Due to the high difference in boiling temperature, the trichlorosilane and tetrachlorosilane content can be removed easily by distillation to obtain the oligochlorosilanes in pure form.

### EXAMPLE 2

The procedure described in example 1 is repeated, except that the mechanical blend now consisted of 98.35% by weight of Si and 1.65% by weight of CuCl/ZnCl₂/tin chloride. The weight ratio of Cu metal to Zn and Sn is as specified in example 1. The yield of oligochlorosilanes is reported in table 1; the most important constituents of the condensate are listed in table 2.

### EXAMPLE 3

The procedure described in example 1 is repeated, except that the mechanical blend now consisted of 96.7% by weight of Si and 3.3% by weight of CuCl/ZnCl₂/tin chloride. The weight ratio of Cu metal to Zn and Sn is as specified in example 1. The yield of oligochlorosilanes is reported in table 1; the most important constituents of the condensate are listed in table 2.

### EXAMPLE 4

The procedure described in example 1 is repeated, except that 934 g of Si and 66 g of CuCl/ZnCl₂/tin chloride are now used and supplied continuously to the rotary tube furnace. The reactive mixture is likewise emptied continuously out of the rotary tube. The amount added and emptied is 500 g of material per h. In other words, the experiment has ended after 2 h and the rotary tube furnace is emptied completely. The weight ratio of Cu metal to Zn and Sn is as specified in example 1. The yield of oligochlorosilanes obtained is reproduced in table 1; the most important constituents of the condensate are listed in table 2.

### EXAMPLE 5

The procedure described in example 1 is repeated, except that the mechanical blend now consisted of 86.8% by weight of Si and 13.2% by weight of CuCl/ZnCl₂/tin chloride. The weight ratio of Cu metal to Zn and Sn is as specified in example 1. The yield of oligochlorosilanes is reported in table 1; the most important constituents of the condensate are listed in table 2.

### EXAMPLE 6

The procedure described in example 1 is repeated, except that the blend used now consisted of 73.6% by weight of Si and 26.4% by weight of CuCl/ZnCl₂/tin chloride. The weight ratio of Cu metal to Zn and Sn is as specified in table 1. The yield of oligochlorosilanes is reported in table 1; the most important constituents of the condensate are listed in table 2.

TABLE 1

| | Metal chloride | Yield of |
|---|---|---|
| | concentration in % by | oligochlorosilanes in |
| Example | weight | % by weight |
| 1 | 0.55 | 6.00 |
| 2 | 1.65 | 25.53 |
| 3 | 3.3 | 29.72 |
| 4 | 6.6 | 24.48 |
| 5 | 13.2 | 8.34 |
| 6 | 26.4 | 2.29 |

The figures for the metal chloride concentration in % by weight in table 1 are based on the reaction mixture consisting of silicon and metal chloride mixture.

The figures for the yield of oligochlorosilanes in % by weight are based on the metal chloride mixture used in the reaction mixture.

TABLE 2
Main constituents of the condensates obtained
in % by weight

| | | Composition of the chlorosilane | | |
|---|---|---|---|---|
| | Metal chloride | mixture in % by weight | | |
| | concentration | Hexachloro- | | |
| Example | in % by weight | disilane | SiHCl₃ | SiCl₄ |
| 1 | 0.55 | 2.99 | 26.37 | 62.51 |
| 2 | 1.65 | 9.36 | 17.57 | 70.12 |
| 3 | 3.3 | 11.06 | 17.09 | 68.21 |
| 4 | 6.6 | 6.25 | 20.63 | 71.91 |
| 5 | 13.2 | 2.49 | 11.18 | 85.9 |
| 6 | 26.4 | 0.65 | 9.77 | 89.24 |

### EXAMPLE 7

The procedure described in example 1 is repeated, except that the blend used consists of 94% by weight of Si and 6% by weight of CuCl. The yield of oligochlorosilanes in this example is 22.3% by weight, based on the CuCl used.

### EXAMPLE 8

The procedure described in example 1 is repeated, except that the mechanical blend composed of 98.5% by weight of silicon and 1.5% by weight of a metal chloride mixture consisting of (NH₄)₂[SnCl₆] and ZnCl₂ in a ratio of 8 to 2 is treated thermally at 280° C. for a period of 20 min. Thereafter, the reaction of the chloride mixture with the Si is complete, which is recognizable by the fact that no further condensate forms in the cooler. The analysis gives a yield of oligochlorosilanes of 22.3% by weight, based on the amount of metal halide mixture used.

1. A process for preparing oligohalosilanes which are selected from oligohalosilanes of the general formulae (1) and (2)
SiₙX₂ₙ₊₂ (1)
SiₘX₂ₘ (2)
in which a mixture comprising silicon and a halide of a metal which is selected from the group consisting of Ti, Zr, Hf, V, Nb, Mo, W, Fe, Co, Ni, Cu, Cd, In, Sn, P, Sb, Bi, S, Se, Te and Pb and mixtures thereof,
is converted at a temperature of −125° C. to 1100° C. and the oligohalosilanes formed are removed with a carrier gas which is selected from the group consisting of N₂, noble gases, CH₃Cl, HCl, CO₂, CO, H₂ and SiCl₄,
where
X is selected from the group consisting of Cl, Br and I,
n is an integer from 2 to 10, and
m is an integer from 3 to 10.

2. The process as claimed in claim 1, in which the silicon used contains not more than 2% by weight of other elements as impurities.

3. The process as claimed in claim 2, in which the other elements are selected from the group consisting of Fe, Ni, Al, Ca, Cu, Zn, Sn, C, V, Mn, Ti, Cr, B, P, and O.

4. The process as claimed in claim 1, in which the metal halide used melts at not more than 600° C.

5. The process as claimed in claim 1, in which X is chlorine.

6. The process as claimed in claim 1, in which the metal of the metal halide is selected from the group consisting of Fe, V, Mo, Ni, Cu, Cd, Sn, P, Sb, Bi, and Pb.

7. The process as claimed in claim 1, in which the temperature is 150° C. to 600° C.

8. The process as claimed in claim 1, in which n has the values of 2, 3 or 4 and m the values of 4, 5 or 6.

9. The process as claimed in claim 1, in which 0.5 to 15 parts by weight of metal halide are used per 100 parts by weight of silicon.

10. The process as claimed in claim 2, in which the metal halide used melts at not more than 600° C.

11. The process as claimed in claim 3, in which the metal halide used melts at not more than 600° C.

12. The process as claimed in claim 11, in which X is chlorine.

13. The process as claimed in claim 12, in which the metal of the metal halide is selected from the group consisting of Fe, V, Mo, Ni, Cu, Cd, Sn, P, Sb, Bi, and Pb.

14. The process as claimed in claim 13, in which the temperature is 150° C. to 600° C.

15. The process as claimed in claim 14, in which n has the values of 2, 3 or 4 and m the values of 4, 5 or 6.

16. The process as claimed in claim 15, in which 0.5 to 15 parts by weight of metal halide are used per 100 parts by weight of silicon.
